(19) United States
(12) Patent Application Publication
(10) Pub. No.: US 2021/0118297 A1
(43) Pub. Date: Apr. 22, 2021

(54) INFORMATION ANALYSIS DEVICE AND ROUTE INFORMATION ANALYSIS METHOD

(71) Applicant: HONDA MOTOR CO., LTD., Tokyo (JP)

(72) Inventors: Shunsuke Kawasaki, Tokyo (JP); Tadashi Kurihara, Tokyo (JP); Minoru Fukumori, Tokyo (JP); Yoshiaki Sugimoto, Tokyo (JP)

(21) Appl. No.: 16/493,946

(22) PCT Filed: Feb. 21, 2018
(86) PCT No.: PCT/JP2018/006242

§ 371 Date: Dec. 28, 2020

(30) Foreign Application Priority Data
Mar. 22, 2017 (JP) 2017-055497

(51) Int. Cl. G08G 1/13; G08G 1/01; G01C 21/34

(52) U.S. Cl. CPC G08G 1/13; G01C 21/3476; G08G 1/0133

(57) ABSTRACT

The purpose of the present invention is to set a more suitable region to carry out an analysis. Provided is an information analysis device including a communication unit, which receives position information of a plurality of vehicles, a storage unit, which stores map information that includes facility positions relating to a plurality of facilities, and segment line information, which has been created using identification factors that are included in the map information, and an analysis information generation unit, which, on the basis of the received position information, identifies, for each vehicle that has visited any of the plurality of facilities, the start position in the outbound route and/or the parking position in the return route when the facility in question has been visited, and generates analysis information for displaying the identified position overlaid with the map information for each region as segmented by the segment line information.

### TECHNICAL FIELD

The present invention relates to an information analysis device and a route information analysis method for carrying out an information analysis with respect to a movable body visiting to a facility.

### BACKGROUND ART

In the related art, a technology has been known in which position information of a movable body such as a vehicle is acquired, and various analyses are carried out on the basis of the acquired position information. An example of such a technology, for example, is disclosed in Patent Document 1. In the technology disclosed in Patent Document 1, probe information output by a portable terminal that is moved along with a movable body is analyzed, and thus, a movement route of the movable body, and positions of a start point and an end point of the movement route are identified. Then, it is assumed how the movable body visiting to a facility (for example, a station) that is the end point visits to the facility from which start point through which route, on the basis of the identified movement route, and the identified positions of the start point and the end point.

Patent Document 1: Japanese Unexamined Patent Application, Publication No. 2015-76005

### DISCLOSURE OF THE INVENTION

### Problems to be Solved by the Invention

In the case of using the technology disclosed in Patent Document 1, and the like, the start point or the movement route at the time of visiting to the facility can be assumed, and thus, such an assumption result can be used for analyzing a trading zone, or the like. However, in the technology disclosed in Patent Document 1, a determination criterion of a region for obtaining statistical information with respect to the movable body starting from a certain region as the start point varies in flux. Specifically, as disclosed in Paragraph [0053] of the specification or FIG. 7 in Patent Document 1, the position or the arrangement of the region is determined afterwards in accordance with the number of movable bodies starting from the start point, whether or not the movable body comes close, or the like. A case is also considered in which the determination criterion of the region that depends on such a movement situation is not suitable for the application of quantitative comparison, and the like.

The present invention has been made in consideration of such circumstances, and an object of the present invention is to provide an information analysis device and a route information analysis method that are capable of setting a more suitable region to carry out an analysis.

### Means for Solving the Problems

(1) An information analysis device (for example, an information analysis device 30 described below) of the present invention, includes: a receiving unit (for example, a communication unit 33 described below) that receives position information of a plurality of movable bodies (for example, vehicles 60 described below); a storage unit (for example, a storage unit 32 described below) that stores map information (for example, map information 321 described below) including a facility position relevant to a plurality of facilities, and identification factors, and segment line information (for example, segment line information 322 described below) created by using the identification factors included in the map information; and an analysis information generation unit (for example, an analysis information generation unit 312 described below) that identifies any one or both of a start position on an outbound route and a parking position on a return route when the movable body visits to any one facility of the plurality of facilities, on the basis of the received position information, and generates analysis information for displaying the identified position overlaid with the map information for each region that is segmented by the segment line information.

According to (1) described above, an analysis result is displayed by being overlaid on the region that is segmented by the segment line information created by using the identification factors included in the map information. Accordingly, according to (1) described above, an effect is obtained in which it is possible to set a more suitable region to carry out an analysis. In addition, an effect is also obtained in which any one or both of the start position on the outbound route and the parking position on the return route when the movable body visits to the facility, relevant to the plurality of facilities, is identified by the analysis, and thus, it is possible to display such information to a user or the like as the analysis information.

(2) In the information analysis device according to (1) described above, the analysis information generation unit may further receive designation of at least one facility from the plurality of facilities, identify any one or both of the start position on the outbound route and the parking position on the return route when the movable body visits to any one of the plurality of designated facilities, on the basis of the received position information, and generate the analysis information for displaying the identified position overlaid with the map information and the segment line information.

According to (2) described above, the designation of the facility is received, and thus, it is possible to carry out the analysis according to the designation. Accordingly, an effect is obtained in which the user is capable of carrying out a desired analysis.

(3) In the information analysis device according to (1) or (2) described above, time information indicating a positioning time of the position information may be incidental to the position information of the movable body that is received by the receiving unit, and the analysis information generation unit may further receive designation of a time zone, identify any one or both of the start position on the outbound route and the parking position on the return route when the movable body visits to any one facility of the plurality of facilities at the designated time zone, on the basis of the received position information, and generate the analysis information for displaying the identified position overlaid with the map information and the segment line information.

According to (3) described above, the designation of the time zone is received, and thus, it is possible to carry out the analysis according to the designation. Accordingly, an effect is obtained in which the user is capable of carrying out a desired analysis.

(4) In the information analysis device according to any one of (1) to (3) described above, the identification factors of the map information may include at least any one of a river, a railroad, and an arterial road.

According to (3) described above, a region is set by using the information such as the river, the railroad, and the arterial road as the identification factors, and then it is possible to carry out the analysis. Accordingly, an effect is obtained in which it is possible to carry out the analysis corresponding to each region that is divided by the river, the railroad, and the arterial road.

(5) In the information analysis device according to any one of (1) to (4) described above, the analysis information generation unit may further generate the analysis information for displaying the identified start position or the identified parking position such that it is possible to determine which position when the movable body visits to which facility is the start position or the parking position.

According to (5) described above, it is possible to determine the analysis result of each of the facilities. For this reason, an effect is obtained in which the user is capable of easily grasping the contents of the analysis result.

(6) In the information analysis device according to any one of (1) to (5) described above, the receiving unit may further receive activation information and suspension information of the plurality of movable bodies, and the analysis information generation unit may further identify a position in which the movable body is activated on the outbound route, as the start position on the outbound route on the basis of the position information and the activation information, and identify a position in which the movable body is suspended on the return route, as the parking position on the outbound route on the basis of the position information and the suspension information.

According to (6) described above, an effect is obtained in which it is possible to accurately identify the start position and the parking position on the basis of the activation information and the suspension information.

(7) An information analysis method of the present invention is information analysis method performed by a computer (for example, the information analysis device 30 described below), and includes: a receiving step of receiving position information of a plurality of movable bodies (for example, the vehicles 60 described below); a storing step of storing map information (for example, the map information 321 described below) including a facility position relevant to a plurality of facilities, and identification factors, and segment line information (for example, the segment line information 322 described below) created by using the identification factors included in the map information; and an analysis information generating step of identifying any one or both of a start position on an outbound route and a parking position on a return route when the movable body visits to any one facility of the plurality of facilities, on the basis of the received position information, and of generating analysis information for displaying the identified position overlaid with the map information for each region that is segmented by the segment line information.

According to the method of (7) described above, the same effects as those of the information analysis device of (1) are obtained.

### Effects of the Invention

According to the present invention, it is possible to set a more suitable region to carry out an analysis.

### BRIEF DESCRIPTION OF THE DRAWINGS

FIG. 1 is a block diagram illustrating a basic configuration of the entire information analysis system that is an embodiment of the present invention.

FIG. 2 is a functional block diagram illustrating a functional configuration of an onboard navigation device in the embodiment of the present invention.

FIG. 3 is a functional block diagram illustrating a functional configuration of a portable terminal in the embodiment of the present invention.

FIG. 4 is a functional block diagram illustrating a functional configuration of an information analysis device in the embodiment of the present invention.

FIG. 5 is a diagram illustrating an example of a position information database in the embodiment of the present invention.

FIG. 6 is a functional block diagram illustrating a functional configuration of an analysis information reference terminal in the embodiment of the present invention.

FIG. 7 is a diagram illustrating an example of map information for displaying analysis information in the embodiment of the present invention.

FIG. 8 is a diagram illustrating a display example (a map, a mesh region, and an analysis result display) of the analysis information in the embodiment of the present invention.

FIG. 9 is a diagram illustrating an example of the map information and segment line information for displaying the analysis information in the embodiment of the present invention.

FIG. 10 is a diagram illustrating another display example (the map, a segment region, and the analysis result display) of the analysis information in the embodiment of the present invention.

FIG. 11 is a flowchart illustrating a basic operation at the time of collecting the position information and of updating the position information database in the embodiment of the present invention.

FIG. 12 is a flowchart illustrating a basic operation at the time of information analysis processing in the embodiment of the present invention.

### PREFERRED MODE FOR CARRYING OUT THE INVENTION

Hereinafter, a preferred embodiment of an information analysis system of the present invention will be described in detail with reference to the drawings.

<Entire Configuration of Information Analysis System 1>

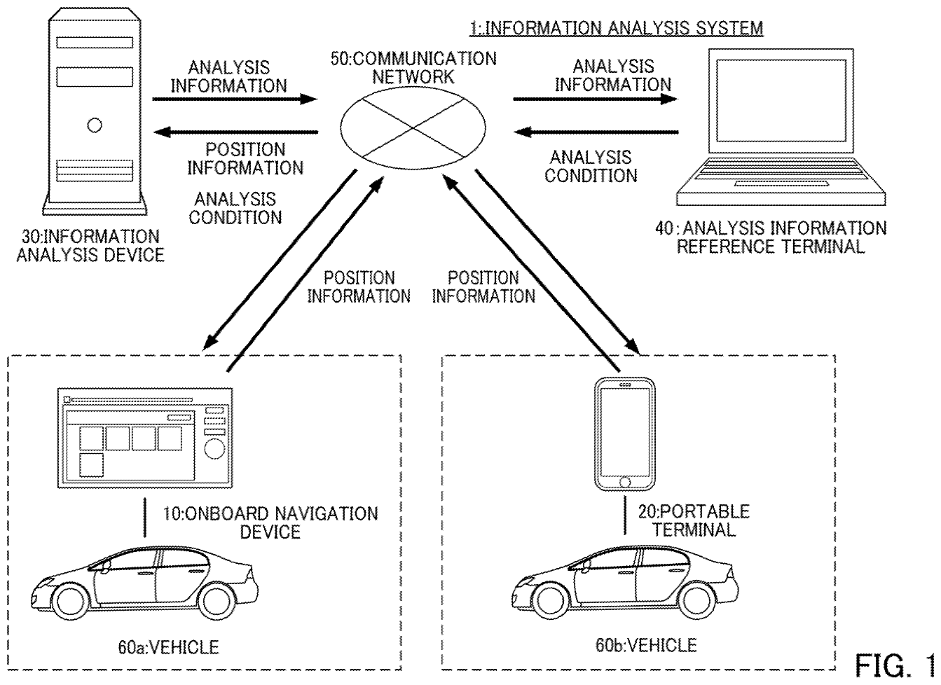

An information analysis system 1 according to a preferred embodiment of the present invention will be described. FIG. 1 illustrates the entire configuration of the information analysis system 1.

As illustrated in FIG. 1, the information analysis system 1 is configured by including an onboard navigation device 10, a portable terminal 20, an information analysis device 30, and an analysis information reference terminal 40. Each device and each terminal can be connected to communicate with each other through a communication network 50. Furthermore, in the drawing, information that is transmitted and received with respect to each device and each terminal is illustrated, but such information is merely an example. In this embodiment, information other than the illustrated information may be transmitted and received.

The onboard navigation device 10 is a device performing navigation (route guidance) with respect to a user in a vehicle 60a. The onboard navigation device 10 performs the route guidance from a current position to a destination, on the basis of the request of the user. In addition, the onboard navigation device 10 also has a function of positioning position information of the onboard navigation device 10 (that is, position information of the vehicle 60a). The position information that is positioned by the onboard navigation device 10 is suitably transmitted to the information analysis device 30. The onboard navigation device 10 can be realized by a car navigation device fixed to the vehicle 60a that is a movable body, or a portable navigation device (PND) simply disposed on the vehicle 60a that is the movable body.

The portable terminal 20 is a portable terminal used by the user in a vehicle 60b. As with the onboard navigation device 10 described above, the portable terminal 20 has a function of positioning position information of the portable terminal 20 (that is, position information of the vehicle 60b). As with the position information that is positioned by the onboard navigation device 10, the position information that is positioned by the portable terminal 20 is suitably transmitted to the information analysis device 30. The portable terminal 20 can be realized by a smart phone, a portable telephone, a tablet terminal, a laptop computer, and other portable electronic devices.

Furthermore, in the drawing, a combination of the onboard navigation device 10 and the vehicle 60a, and a combination of the portable terminal 20 and the vehicle 60b are illustrated one by one, but the number of such combinations is not particularly limited. In addition, in the following description, in the case of not distinguishing the vehicle 60a on which the onboard navigation device 10 is mounted, from the vehicle 60b in which the user using the portable terminal 20 exists, the suffix alphabet will be omitted, and the vehicles 60a and 60b will be simply referred to as a “vehicle 60”.

The information analysis device 30 is a device carrying out analysis processing after a more suitable region is set to carry out an analysis, as unique processing of this embodiment. The information analysis device 30 acquires the position information of each of the vehicles 60 from the onboard navigation device 10 or the portable terminal 20, and thus, prepares a position information database that is a database with respect to the position information of each of the vehicles 60. In addition, the information analysis device 30 stores “map information” described below, and “segment line information” created by using identification factors included in the map information. Then, the information analysis device 30 sets a region on the basis of the map information and the segment line information. Then, the information analysis device 30 generates “analysis information” for displaying an analysis result of the position information of each of the vehicles 60 that is stored in the created position information database, overlaid with the map information and the segment line information to correspond to the set region. That is, according to this embodiment, it is possible to carry out an analysis after a more suitable region is set to carry out the analysis.

The generated analysis information is transmitted to the analysis information reference terminal 40 from the information analysis device 30, and is displayed on the analysis information reference terminal 40 with respect to the user. Furthermore, the analysis information is generated to be coincident with an “analysis condition” that is transmitted by the analysis information reference terminal 40 on the basis of the input of the user. The details of the segment line information, the analysis information, or the analysis condition will be described below. The information analysis device 30, for example, can be realized by a server device.

The analysis information reference terminal 40 is a terminal which is operated by the user using the analysis information. The user using the analysis information inputs a desired analysis condition with respect to the analysis information reference terminal 40, in order to obtain the analysis information according to a desired condition. The input analysis condition is transmitted to the information analysis device 30. In this case, as described above, the information analysis device 30 generates the analysis information corresponding to the analysis condition, and sends a reply with respect to the analysis information reference terminal 40. Then, the analysis information reference terminal 40 outputs the received analysis information with respect to the user using the analysis information.

As described above, the user of the analysis information reference terminal 40 is capable of obtaining the analysis information according to the desired condition. Then, the user, for example, is capable of knowing from which region a customer visits to any one facility of the plurality of facilities, or to which region the customer returns after visiting the facility, on the basis of the analysis information. In addition, it is possible to determine and know to which facility of the plurality of facilities the customer visits. That is, the analysis result according to this embodiment can be provided as information advantageous for the user. Furthermore, the analysis information reference terminal 40, for example, can be realized by a personal computer.

The communication network 50 is realized by a network such as the internet or a portable telephone network, and a network such as a combination thereof. In addition, a local area network (LAN) may be included in a part of the network (for example, between the information analysis device 30 and the analysis information reference terminal 40).

The vehicle 60 is a movable body in which the onboard navigation device 10 or the user of the portable terminal 20 exists. The vehicle 60, for example, is realized by a four-wheel vehicle, a motorcycle, a bicycle, or the like.

<Functional Block of Onboard Navigation Device 10>

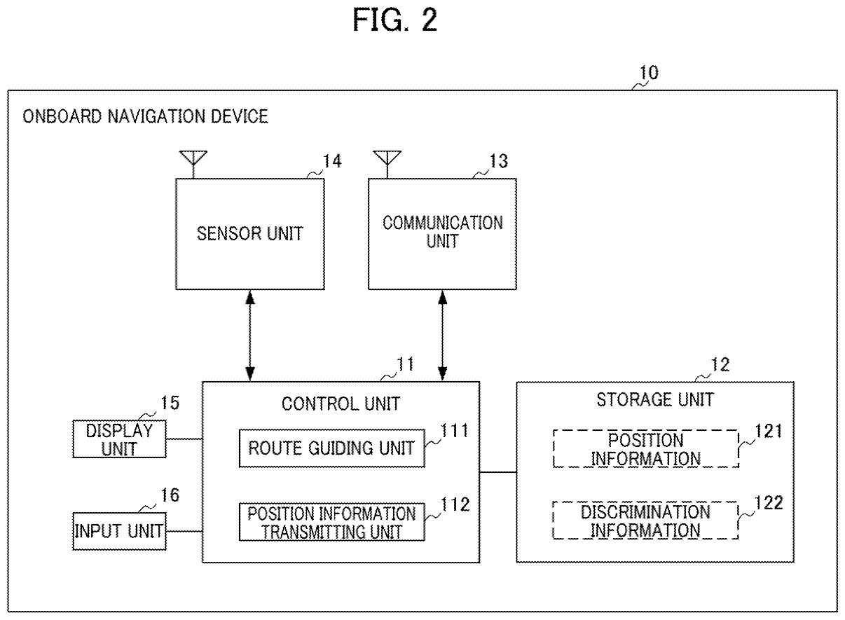

Next, a functional block of the onboard navigation device 10 will be described with reference to a block diagram of FIG. 2. Here, a power source is supplied from the vehicle 60a, and an ignition-switch-on state of the vehicle 60a is set by the user in the vehicle 60a (an engine is activated), and thus, the onboard navigation device 10 is automatically activated. Then, the onboard navigation device 10 is operated until an ignition-switch-off state of the vehicle 60a is set by the user in the vehicle 60a (the engine is suspended).

As illustrated in FIG. 2, the onboard navigation device 10 is configured by including a control unit 11, a storage unit 12, a communication unit 13, a sensor unit 14, a display unit 15, and an input unit 16.

The control unit 11 is configured of an arithmetic processing device such as a microprocessor, and controls each unit configuring the onboard navigation device 10. The details of the control unit 11 will be described below.

The storage unit 12 is configured of a semiconductor memory or the like, and stores each program such as a control program referred to as firmware or an operating system, a program for performing route guidance processing, and a program for performing transmission processing of the position information with respect to the information analysis device 30, and various information items such as the map information. In the drawing, position information 121 and discrimination information 122 that are information particularly relevant to the transmission processing of the position information, are illustrated as the information stored in the storage unit 12.

The position information 121 is the position information of the onboard navigation device 10 (that is, the position information of the vehicle 60a) that is positioned by the sensor unit 14 described below. The position information 121 may include not only information indicating a position that is positioned, but also a time when the positioning is performed. In addition, the discrimination information 122 is information for discriminating the onboard navigation device 10. For example, a production number or the like that is uniquely assigned to the onboard navigation device 10 can be used as the discrimination information 122. In addition, in order for the communication unit 13 to be connected to the communication network 50 that is a network, such as a portable telephone network, a telephone number applied to a subscriber identity module (SIM) inserted into the communication unit 13 can be used as the discrimination information 122. In addition, a vehicle identification number (VIN) or a number of a number plate that is intrinsically applied to the vehicle 60a can be used as the discrimination information 122.

Each of the information items stored in the storage unit 12 may be stored in advance in the storage unit 12, or may be suitably downloaded from a server device or the like (not illustrated) that is connected to the communication network 50, as necessary. Further, the information may be suitably corrected in accordance with the input of the user, or the like.

The communication unit 13 includes a digital signal processor (DSP) or the like, and realizes wireless communication with respect to other devices via the communication network 50 (for example, the information analysis device 30) through the communication network 50, on the basis of a standard such as 3rd generation (3G), long term evolution (LTE), and Wi-Fi. The communication unit 13, for example, is used for a position information transmitting unit 112 described below to transmit the position information 121 and the discrimination information 122 that are stored in the storage unit 12 to the information analysis device 30. However, data that is transmitted and received between the communication unit 13 and the other device is not particularly limited, and information other than the position information 121 and the discrimination information 122 may be transmitted and received.

The sensor unit 14, for example, is configured of a global positioning system (GPS) sensor, a gyro sensor, an acceleration sensor, and the like. The sensor unit 14 has a function as a position detection unit that detects the position information, receives a GPS satellite signal from a GPS sensor, and positions the position information (a latitude and a longitude) of the onboard navigation device 10. The positioning of the sensor unit 14 is performed at a predetermined time interval (for example, a three-seconds interval) as described above. The position information that is positioned is stored in the storage unit 12 as the position information 121. Furthermore, in the sensor unit 14, it is possible to further increase a positioning accuracy of the position information of the onboard navigation device 10 on the basis of an angular rate or an acceleration rate that is measured by a gyro sensor and an acceleration sensor. In addition, in a case where it is difficult to or it is not possible to perform GPS communication, the sensor unit 14 is also capable of calculating the position information of the onboard navigation device 10 by base station information that is acquired from the communication unit 13, by using assisted global positioning system (AGPS) communication.

The display unit 15 is configured of a display device such as a liquid crystal display or an organic electroluminescence panel. The display unit 15 receives an instruction from the control unit 11, and displays an image. Examples of the information displayed on the display unit 15 include the current position of the onboard navigation device 10, map information of the vicinity of the current position of the onboard navigation device 10 that is read out from the map information, a destination that is set by the user 20, meeting information that is notified from the other onboard navigation device 10, route information, various user interfaces, and the like.

The input unit 16 is configured of an input device (not illustrated) such as a physical switch referred to as a numeric keypad or a touch panel that is disposed by being overlaid with a display surface of the display unit 15, and the like. A signal based on operation input from the input unit 16, such as the press of the numeric keypad of a user 20 and the touch of the touch panel, is output to the control unit 11, and thus, a selection operation of the user 20 and a scaling operation of a map can be realized.

Furthermore, even though it is not illustrated, a speaker, a microphone, or the like can be provided. The speaker outputs sound with respect to a driver, and the microphone collects a sound generated by the driver. As described above, information can be output from the speaker as a sound, or various selections or instructions of the driver to whom a sound is input through the microphone can be input into the control unit 11 by a sound recognition technology.

Next, the details of the control unit 11 will be described. The control unit 11 is configured of a microprocessor including a central processing unit (CPU), a random access memory (RAM), a read only memory (ROM), input/output (I/O), and the like. The CPU executes each program that is read out from the ROM or the storage unit 12, reads out the information from the RAM, the ROM, and the storage unit 12 when the program is executed, and writes the information with respect to the RAM and the storage unit 12, and thus, performs the delivery of the signal with respect to the communication unit 13, the sensor unit 14, the display unit 15, and the input unit 16. Then, hardware and software (a program) cooperate with each other, and thus, the processing of this embodiment is realized.

The control unit 11 includes a route guiding unit 111 and a position information transmitting unit 112, as a functional block.

The route guiding unit 111 is a portion performing route guidance processing up to the destination such as a facility that is input or selected by the user. The route guidance processing up to the destination is identical to the route guidance processing in a general car navigation system. That is, the route guiding unit 111 generates a map up to the destination, on the basis of the map information (not illustrated) that is stored in the storage unit 12, overlays the current position of the onboard navigation device 10 that is positioned by the sensor unit 14, the position of the destination, and the route information up to the destination on the map, and displays the information on the display unit 15, and thus, is capable of performing the route guidance. In this case, a sound for route guidance may be further output from the speaker (not illustrated). In addition, information of a road congestion situation, weather information, or the like may be acquired through the communication of the communication unit 13, and the acquired information may be used for the route guidance processing. Furthermore, the route guidance processing up to the destination is well known for a person skilled in the art, and thus, the detailed description thereof will be omitted.

The position information transmitting unit 112 is a portion transmitting the position information 121 and the discrimination information 122 that are stored in the storage unit 12 with respect to the information analysis device 30, through wireless communication using the communication unit 13. The transmission of the position information 121 and the discrimination information 122 with respect to the information analysis device 30 by the position information transmitting unit 112 is periodically performed after the ignition-switch-on state of the vehicle 60a is set (the engine is activated) by the user in the vehicle 60a, and the onboard navigation device 10 is automatically activated, until the ignition-switch-off state of the vehicle 60a is set (the engine is suspended). For example, every time when the sensor unit 14 performs the positioning at a predetermined time interval (for example, a three-seconds interval), the information is transmitted in real time. In addition, a plurality of information items (for example, the position information 121 and the discrimination information 122 that are updated at a three-seconds interval for 3 minutes) may be transmitted at one time, instead of performing the transmission with respect to the information analysis device 30 in real time. That is, so-called burst transmission may be performed. The length of the predetermined time interval, and the real-time transmission or the burst transmission can be arbitrarily set in accordance with an environment or the like to which the present embodiment is applied. As described above, the real-time transmission or the burst transmission is performed, and thus, the position information transmitting unit 112 transmits the position information 121 and the discrimination information 122 for identifying the movement route of the vehicle 60a that is positioned by the sensor unit 14, with respect to the information analysis device 30.

In this case, the ignition-switch-on state is set (the engine is activated), and a position identified by the position information 121 that is positioned immediately after the onboard navigation device 10 is automatically activated can be transmitted to the information analysis device 30, as an initial vehicle position, that is, a start position. Further, a position identified by the position information 121 that is positioned immediately before the ignition-switch-off state is set (the engine is suspended) can be transmitted to the information analysis device 30, as a final vehicle position, that is, a parking position. In this case, the activation information that is the position information 121 indicating the start position, or the suspension information that is the position information 121 indicating the parking position may be added to the position information 121, and then, may be transmitted to the information analysis device 30. For example, a flag indicating the activation information may be transmitted as 1, or a flag indicating the suspension information may be transmitted as 1. Furthermore, the position information 121 (that is, a stop position) that is positioned immediately before the ignition-switch-off state is set (the engine is suspended) may be transmitted when the ignition-switch-on state is set (the engine is activated), and the onboard navigation device 10 is activated again.

In addition, even in the case of performing the burst transmission, in a case where it is determined that the vehicle 60a arrives at the destination (that is, the parking position) by the route guiding unit 111, the position information transmitting unit 112 may be switched to perform the real-time transmission. Accordingly, it is possible to prevent the position information 121 of the destination such as the facility from not being transmitted with respect to the information analysis device 30 due to the setting of the ignition-switch-off state (the suspension of the engine) after arriving at the parking position and before transmitting the position information 121 of the parking position.

<Functional Block of Portable Terminal 20>

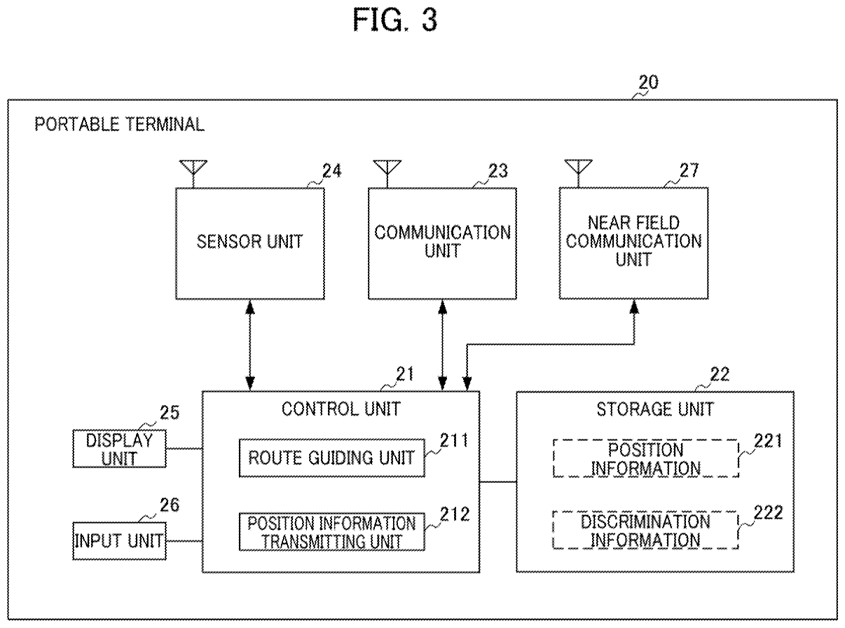

Next, a functional block of the portable terminal 20 will be described with reference to a block diagram of FIG. 3. Here, the onboard navigation device 10 described above receives the supply of the power source from the vehicle 60a, but the portable terminal 20 receives the supply of the power source from a battery (not illustrated) provided therein. However, in order to charge the battery, the portable terminal 20 may receive the supply of the power source from a cigarette socket or the like of the vehicle 60b.

As illustrated in FIG. 2, the portable terminal 20 is configured by including a control unit 21, a storage unit 22, a communication unit 23, a sensor unit 24, a display unit 25, an input unit 26, and a near field communication unit 27. Here, the control unit 21, the storage unit 22, the communication unit 23, the sensor unit 24, the display unit 25, and the input unit 26 have the same functions as those of the functional blocks of the same names included in the onboard navigation device 10 described above. That is, each of the functional blocks of the portable terminal 20 will be described by replacing the “onboard navigation device 10” in the description of the onboard navigation device 10 described above with the “portable terminal 20”, and thus, the overlapping description will be omitted.

On the other hand, the portable terminal 20 is different from the onboard navigation device 10 in that the portable terminal 20 includes the near field communication unit 27, and thus, the difference will be described below. The near field communication unit 27 is a portion for performing non-contact near field communication based on a standard such as near field communication (NFC) or Bluetooth (Registered Trademark), or wired near field communication through a universal serial bus (USB) cable or the like. On the other hand, the vehicle 60b includes a near field communication unit for performing communication with respect to the near field communication unit 27. For example, an electronic control unit (ECU) of the vehicle 60b includes the near field communication unit. Then, there is a case where the portable terminal 20 is capable of performing the communication with respect to the ECU through the near field communication, that is, a case where the portable terminal 20 exists in the vehicle 60b. In this case, the position information of the portable terminal 20 that is positioned by the sensor unit 24 corresponds to the position information of the vehicle 60b.

Therefore, a position information transmitting unit 212 is activated while the portable terminal 20 is capable of performing the near field communication with respect to the ECU through the near field communication unit 27. Then, as with the position information transmitting unit 112 of the onboard navigation device 10, the activated position information transmitting unit 212 transmits position information 221 and discrimination information 222 for identifying the movement route of the vehicle 60b that is positioned by the sensor unit 24 with respect to the information analysis device 30.

For example, in a case where the user possessing the portable terminal 20 is in the vehicle 60b, and sets an activation switch of the vehicle 60b, such as an ignition switch, to ON, the vehicle 60b and the portable terminal 20 are connected to each other (paired with each other), and the position information 221 that is positioned by the portable terminal 20, and the discrimination information 222 are transmitted to the information analysis device 30 from the portable terminal 20. In this case, a position identified by the position information 121 that is positioned immediately after the vehicle 60b and the portable terminal 20 are paired with each other can be transmitted to the information analysis device 30, as the initial vehicle position, that is, the start position.

Further, in a case where the activation switch of the vehicle 60b, such as the ignition switch, is set to Off, the pairing between the vehicle 60b and the portable terminal 20 is released. In this case, a position identified by the position information 121 that is positioned immediately before the pairing between the vehicle 60b and the portable terminal 20 is released can be transmitted to the information analysis device 30, as the final vehicle position, that is, the parking position. In this case, as with the position information transmitting unit 112, the real-time transmission may be performed, or the burst transmission may be performed, the burst transmission may be switched to the real-time transmission in a case where it is determined that the vehicle arrives at the parking position, the information indicating the start position or the parking position may be added, and the parking position may be transmitted at the time of performing re-activation.

Furthermore, in a case where the vehicle 60b has a function of positioning the position information, the position information that is positioned by the vehicle 60b but not the position information that is positioned by the sensor unit 24 may be transmitted to the information analysis device 30, as the position information 121. In this case, the sensor unit 24 may be omitted from the portable terminal 20.

<Functional Block of Information Analysis Device 30>

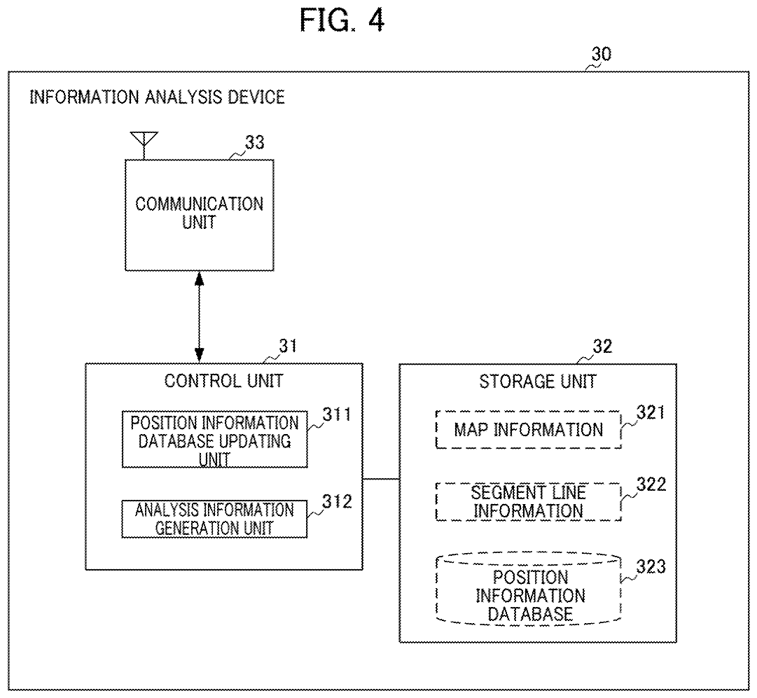

Next, a functional block of the information analysis device 30 will be described with reference to a block diagram of FIG. 4.

As illustrated in FIG. 4, the information analysis device 30 includes a control unit 31, a storage unit 32, and a communication unit 33.

The control unit 31 is configured of an arithmetic processing device such as a microprocessor, and controls each unit configuring the information analysis device 30. The details of the control unit 31 will be described below.

The storage unit 32 is configured of a semiconductor memory or the like, and stores a control program referred to as firmware or an operating system, each program such as a program for performing the information analysis processing, and various information items such as the map information. In the drawing, map information 321, segment line information 322, and a position information database 323 that are information particularly relevant to the analysis processing of the position information are illustrated as the information stored in the storage unit 32.

The map information 321 includes information such as information relevant to a feature such as a road or a facility, road information, facility position information, and parking lot information. In addition, the map information 321 further includes road network data including map data for displaying a background of a road, a road map, and the like, position information of a node (for example, an intersection, a bending point, a corner point, or the like of the road) and type information thereof, position information of a link that is a route connecting the nodes and type information thereof, link cost data relevant to cost information of all of the links (for example, a distance, required time, or the like), and the like.

So-called road map information such as the type of road or a traffic light is stored as the road information. In the facility position information, the position information of each of the facilities is stored as latitude and longitude information. In addition, the facility position information may include incidental information such as discrimination information (a facility ID), a name, facility classification (and/or genre), a telephone number, an address, and an opening hour of the facility, and in a case where the facility is a restaurant, a menu to be provided, and facility information relevant to merchandise service or the like. In the parking lot information, position information of the parking lot is stored as the latitude and longitude information. In a case where the parking lot is a parking lot of each of the facilities, the facility and the parking lot are stored by being associated with each other.

Further, the map information 321 includes “factor information” for creating the segment line information to be described below. Here, the factor information is information indicating factors segmenting a region, and for example, is information such as a river, a railroad, and an arterial road. In this embodiment, in order to carry out an analysis such as a trading zone analysis, a region is segmented by the river, the railroad, the arterial road, and the like, and then, the analysis is performed. In the case of traversing the river, the railroad, and the arterial road, for example, it is necessary to move to a position of a bridge or a crossing or to travel through heavy traffic, and thus, it is considered that there is a certain degree of barrier for movement from the viewpoint of a time or the emotion of the user driving the vehicle 60. Therefore, in this embodiment, a region is partitioned by the river, the railroad, and the arterial road, and thus, an analysis is carried out by considering each of the partitioned regions, for example, as a trading zone. Furthermore, the river, the railroad, and the arterial road are merely an example of the factor information, and other information items may be the factor information.

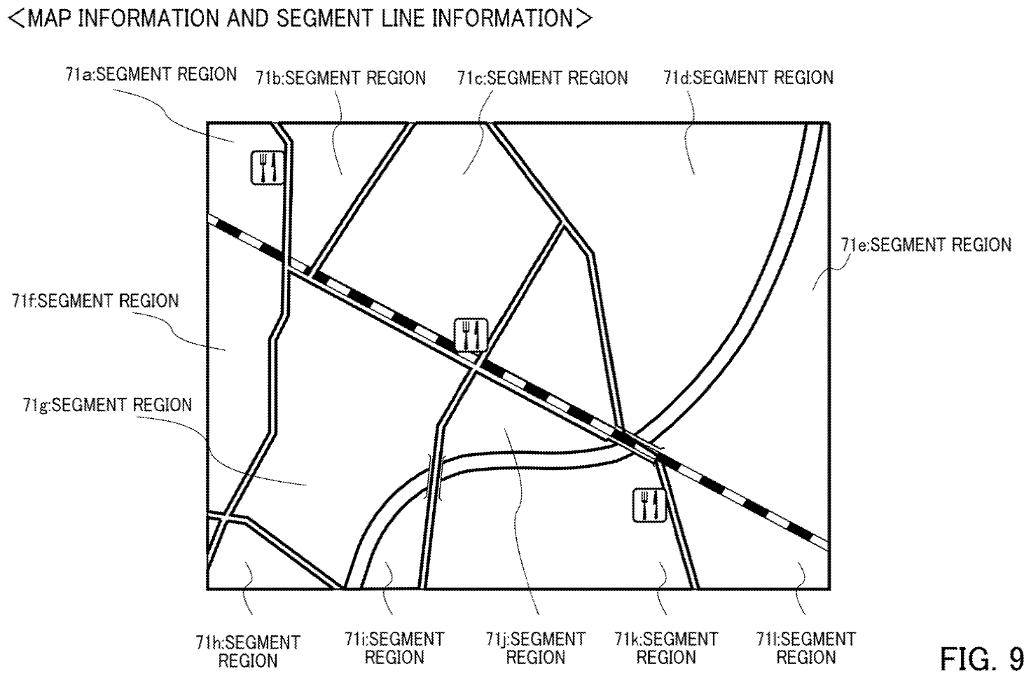

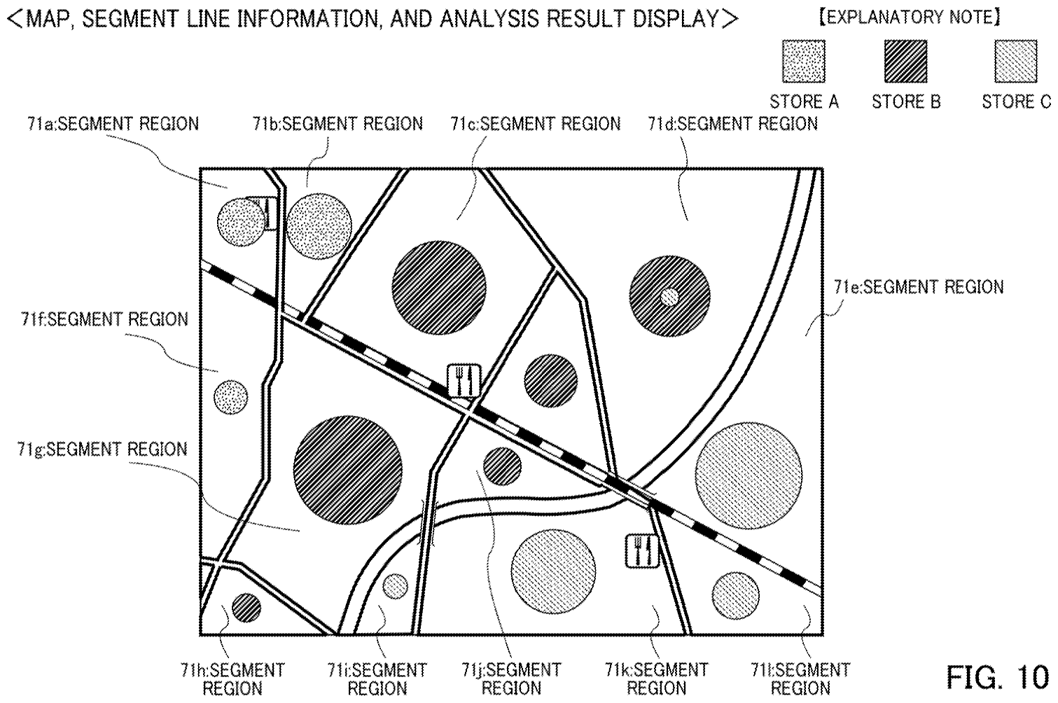

The segment line information 322 is information that is created by the factor information included in the map information 321 described above, and is information for segmenting a region to carry out an analysis such as a trading zone analysis. The segment line information is formed by the river, the railroad, the arterial road, and the like described above. A specific example of the segment of the segment line information will be described below with reference to FIGS. 9 and 10.

The map information 321 and the segment line information 322 may be configured by being stored in advance in the storage unit 32, or may be configured by being suitably downloaded from the server device (not illustrated) or the like that is connected to the communication network 50, as necessary. Further, the map information 321 and the segment line information 322 may be suitably corrected in accordance with the input of the user, or the like. In addition, the control unit 31 may analyze the map information 321, and thus, the segment line information 322 may be created.

The position information database 323 is a database that is constructed on the basis of the position information 121 and the position information 221, and the discrimination information 122 and the discrimination information 222 that are received from the onboard navigation device 10 and the portable terminal 20, respectively. The position information database 323 is constructed by a position information database updating unit 311 described below. The details of the position information database 323 will be described below when the position information database updating unit 311 is described. Furthermore, in the following description, in the case of not distinguishing the position information 121 from the position information 221, the reference numeral will be omitted, and the position information 121 and the position information 221 will be simply referred to as “position information”. In addition, similarly, in the case of not distinguishing the discrimination information 122 from the discrimination information 222, the reference numeral will be omitted, and the discrimination information 122 and the discrimination information 222 will be simply referred to as “discrimination information”.

The communication unit 33 includes a digital signal processor (DSP), and the like, and realizes wireless communication with respect to the other device via the communication network 50 through the communication network 50, on the basis of a standard such as 3rd generation (3G), long term evolution (LTE), or Wi-Fi. The communication unit 33, for example, is used for receiving the position information and the discrimination information that are transmitted from the onboard navigation device 10 and the portable terminal 20, respectively. In addition, the communication unit 33, for example, is used for receiving the analysis condition that is transmitted from the analysis information reference terminal 40. Further, the communication unit 33, for example, is used for transmitting the analysis information with respect to the analysis information reference terminal 40. However, the data that is transmitted and received between the communication unit 33 and the other device is not particularly limited, and information other than the information described above may be transmitted and received.

Next, the details of the control unit 31 will be described. The control unit 31 is configured of a microprocessor including a central processing unit (CPU), a random access memory (RAM), a read only memory (ROM), input/output (I/O), and the like. The CPU executes each program that is read from the ROM or the storage unit 32, reads out the information from the RAM, the ROM, and the storage unit 32 when the program is executed, and writes the information with respect to the RAM and the storage unit 32, and thus, performs the delivery of the signal with respect to the communication unit 33, the sensor unit 34, the display unit 35, and the input unit 36. Then, hardware and software (a program) cooperate with each other in this way, and thus, the processing of this embodiment is realized.

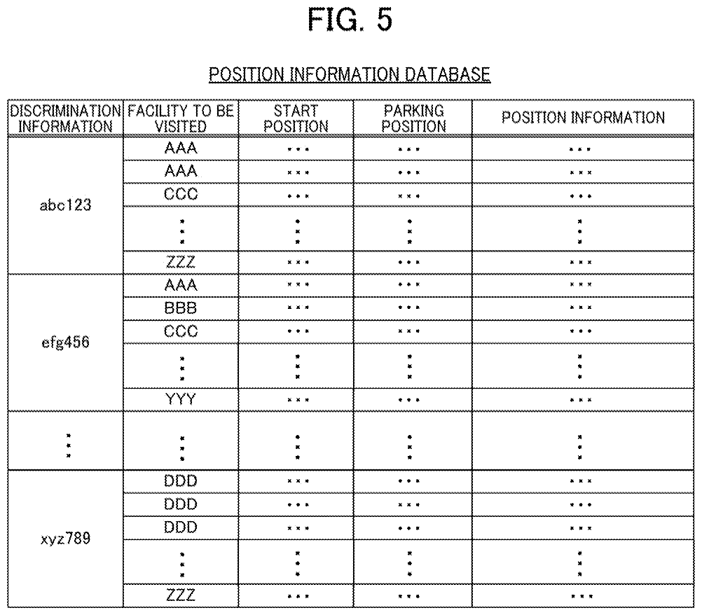

The control unit 31 includes the position information database updating unit 311 and an analysis information generation unit 312, as a functional block. The position information database updating unit 311 is a portion which constructs and suitably updates the position information database 323. An example of a data structure of the position information database 323 will be described with reference to FIG. 5.

As illustrated in FIG. 5, the position information database 323 includes the “discrimination information” and the “position information” that are received from the onboard navigation device 10 and the portable terminal 20, respectively, as described above, and a “facility to be visited”, the “start position”, and the “stop position”, as attribution. Then, the position information database updating unit 311 stores information corresponding to each attribution in a field by using the facility to be visited, the start position, the stop position, and the position information as a combination, for each of the discrimination information items, and thus, creates the position information database 323.

Here, the “discrimination information” in the position information database 323 is information for discriminating the onboard navigation device 10 or the portable terminal 20 that is a transmission source of the position information, as described above. That is, the “discrimination information” is information for discriminating the vehicle 60 corresponding to the onboard navigation device 10 or the portable terminal 20.

In addition, the “facility to be visited” in the position information database 323 is information for discriminating a facility to which the user visits by the vehicle 60. The position information database updating unit 311 identifies the facility to be visited from the position information that is received along with the discrimination information. For example, as described above, a case is considered in which information indicating the parking position is included in the position information. In this case, the parking position is compared to the position of the facility included in the map information 321 (and the position of the parking lot associated with the facility), and in a case where the parking position is coincident with the position of the facility, it is possible to determine that the user visits to the facility by the vehicle 60.

In this case, the discrimination information (a facility ID) of the facility included in the map information 321 is stored in the field of the facility to be visited, in the position information database 323. Furthermore, in a case where the information indicating the parking position is not included in the position information, for example, for example, it is possible to consider a position corresponding to position information that is finally received after the transmission of the position information is started once, as the parking position. In addition, in a case where a position corresponding to position information to be transmitted is not changed for longer than or equal to a defined period of time, it is possible to consider the position as the parking position.

Further, the “start position” in the position information database 323 is information for identifying a position from which the user is started by the vehicle 60. The position information database updating unit 311 identifies the start position from the position information that is received along with the discrimination information. For example, as described above, in a case where the information indicating the start position is included in the position information, the information indicating the start position is stored in the field of the start position, in the position information database 323. Furthermore, in a case where the information indicating the start position is not included in the position information, for example, it is possible to consider a position corresponding to position information that is initially received, as the start position.

Further, the “stop position” in the position information database 323 is information for identifying a position at which the user stops by the vehicle 60. The position information database updating unit 311 identifies the stop position from the position information that is received along with the discrimination information. For example, as described above, in a case where the information indicating the stop position is included in the position information, the information indicating the stop position is stored in the field of the stop position, in the position information database 323. Furthermore, in a case where the information indicating the stop position is not included in the position information, for example, it is possible to consider the position corresponding to the position information that is finally received or a position that is not changed for a defined period of time, as the stop position, as described above. Here, a method of considering the “start position” and the “stop position” that are stored in the position information database 323 in this embodiment will be described. In this embodiment, any one or both of a start position on an outbound route and a parking position on a return route when the vehicle 60 visits to any one facility of the plurality of facilities designated by the analysis information generation unit 312 described below are identified on the basis of the received position information. Then, the analysis information for displaying the start position on the outbound route or the parking position on the return route that is identified as described above overlaid with the segment line information 322 on a map that is generated from the map information 321 is generated. For example, in a case where the user visits a certain facility by the vehicle 60, the vehicle 60 is started from any start position on the outbound route to the facility, and is parked at the facility. Then, the vehicle 60 is started from the facility as the start position, on the return route after visiting to the facility, and is parked at any parking position. In this embodiment, the start position on the outbound route and the parking position on the return route are identified on the basis of the position information of the vehicle 60, and are stored in the position information database 323. Specifically, the position information database updating unit 311 identifies a route in which the parking position is a certain facility, on the basis of the position information that is received from the vehicle 60, and determines the route as the outbound route for visiting to the facility. Then, the position information database updating unit 311 identifies the start position on the outbound route, and stores the start position in the position information database 323 by associating the start position with the facility. Further, the position information database updating unit 311 identifies a route in which the start position is a certain facility, on the basis of the position information that is received from the vehicle 60, and determines the route as the return route starting from the facility to which the vehicle 60 visits. Then, the position information database updating unit 311 identifies the parking position on the return route, and stores the parking position in the position information database 323 by associating the parking position with the facility. Furthermore, the start position on the outbound route and the stop position on the return route may be in different locations. For example, in the case of visiting to the facility after starting from the own home, and then, returning to the own home, the start position on the outbound route and the stop position on the return route are in the same location, but in the case of visiting to the facility after starting from the own home, and then, visiting to another facility or the like, the start position on the outbound route and the stop position on the return route may be in different locations. In this embodiment, it is possible to select which of the start position on the outbound route or the stop position on the return route is analyzed, on the basis of the analysis condition described below.

The “position information” in the position information database 323 is the entire position information after the transmission of the position information is started once, until the transmission of the position information is ended. In this embodiment, after the start position and the stop position described above are identified, the entire position information may not be stored in the position information database 323, but in a case where the entire position information is stored in the position information database 323, it is possible to identify the entire movement route from the start position to the parking position on each of the outbound route and the return route. Accordingly, it is also possible to carry out a more detailed analysis.

The position information database updating unit 311 stores each of the information items described above in a new field, every time when the transmission of the position information and the discrimination information is started once, and then, is ended from any one of the onboard navigation device 10 and the portable terminal 20, on the basis of the position information and the discrimination information that are received, and thus, updates the position information database 323.

Next, the analysis information generation unit 312 will be described. The analysis information generation unit 312 is a portion creating the analysis information according to the analysis condition, on the basis of each of the information items that stored in the storage unit 32 described above. Here, as described above, the analysis condition is a condition that is input by the user of the analysis information reference terminal 40 to obtain desired analysis information. The analysis condition that is input by the user of the analysis information reference terminal 40 is transmitted to the information analysis device 30, and is acquired by the analysis information generation unit 312.

Here, the analysis condition, for example, includes the designation of the facility to be visited that is an analysis target. Here, the number of designated facilities to be visited may be an arbitrary number of greater than or equal to one. For example, in a case where the user of the analysis information reference terminal 40 hopes to “set the vehicle 60 visiting to any one of a facility A, a facility B, and a facility C to the analysis target”, “discrimination information” of each of three facilities is input as the analysis condition. Accordingly, the user of the analysis information reference terminal 40 is capable of setting a desired facility to the analysis target. In addition, a plurality of facilities is set to the analysis target, and thus, it is possible to compare analysis results of the plurality of facilities. For example, in a case where the user of the analysis information reference terminal 40 runs a plurality of restaurants, the plurality of restaurants are included in the analysis condition as a facility, and thus, it is possible to compare analysis results relevant to the visit with respect to each of the restaurants.

Further, for example, a time zone may be input as another analysis condition. Accordingly, the vehicle 60 visiting to the facility at a certain time zone can be set to the analysis target. For example, in the example of the restaurant described above, in a case where the user of the analysis information reference terminal 40 hopes to “set a so-called lunchtime to the analysis target”, the time zone is designated to be 12:00 to 15:00, as the analysis condition. Accordingly, the vehicle 60 visiting to the restaurant from 12:00 to 15:00 can be analyzed as a target.

Further, for example, which of the start position on the outbound route or the stop position on the return route is set to the analysis target may be input as the analysis condition as another analysis condition. For example, in a case where the user of the analysis information reference terminal 40 hopes to “know where the vehicle 60 visiting to the facility comes from”, the start position on the outbound route is designated as the analysis condition. Accordingly, it is possible to know where the vehicle 60 visiting to the facility comes from. In addition, for example, in a case where the user of the analysis information reference terminal 40 hopes to “know where the vehicle 60 visiting to the facility goes to”, the parking position on the return route is designated as the analysis condition. Accordingly, it is possible to known where the vehicle 60 visiting to the facility goes to afterwards.

Further, for example, the distance of the start position on the outbound route and the stop position on the return route from the facility to be visited may be input as the analysis condition as another analysis condition. For example, in the case of displaying even the vehicle 60 that visits to the facility from a place too far from the facility, it is considered that the analysis result is displayed on an extremely large map, and thus, may not be suitable for the analysis. Therefore, a distance from the facility to be visited may be set to the analysis target by being limited. Furthermore, the analysis conditions described above may be arbitrarily combined.

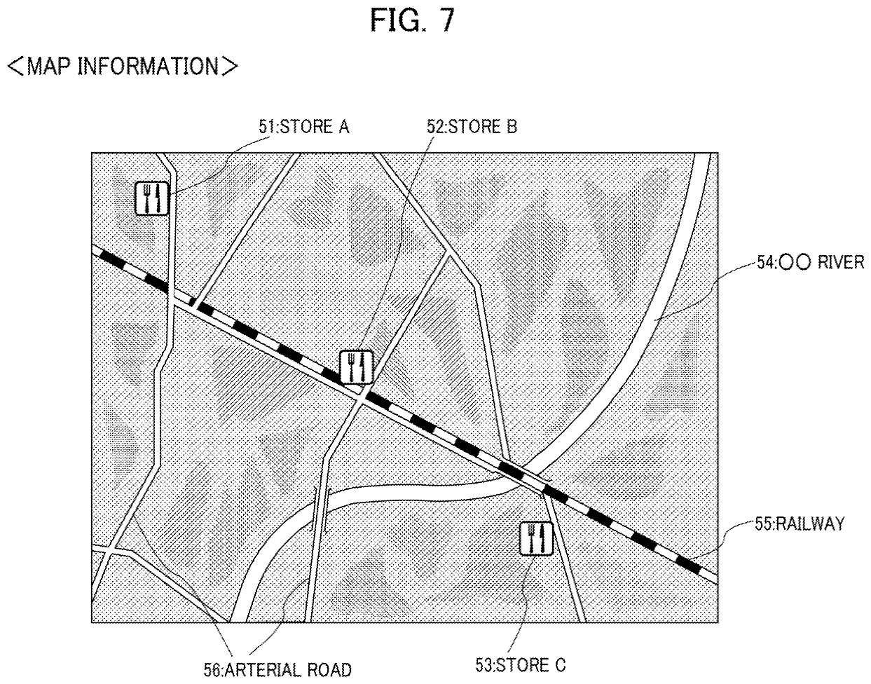

The analysis information generation unit 312 acquires information corresponding to such analysis conditions from the position information database 323, carries out the analysis on the basis of the position information, and generates the analysis information for displaying the analysis result. The analysis information, for example, is generated as image data for displaying an image that is visible for the user. A specific example in the case of displaying the analysis information will be described below with reference to FIGS. 7 to 10, after the analysis information reference terminal 40 is described.

<Functional Block of Analysis Information Reference Terminal 40>

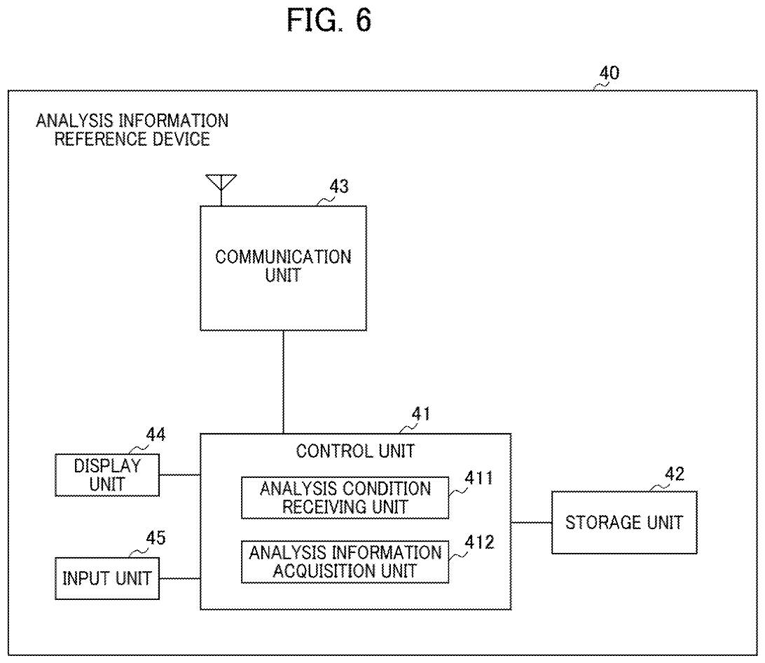

The analysis information reference terminal 40 can be realized by a general personal computer, and thus, the detailed description thereof will be omitted. As illustrated in FIG. 6, a customer terminal 4 includes at least a control unit 41, a storage unit 42, a communication unit 43, a display unit 44, and an input unit 45. The configuration of each unit, for example, is identical to that of each unit having the same name as that of the onboard navigation device 10 or the portable terminal 20.

The control unit 41 includes an analysis condition receiving unit 411 and an analysis information acquisition unit 412. The analysis condition receiving unit 411 generates a user interface for receiving the input of the analysis condition from the user, and displays the generated user interface with respect to the display unit 44 that is realized by a display. The user of the analysis information reference terminal 40 inputs the analysis condition in the input unit 45 that is input by an input interface such as a keyboard or a mouse, with reference to the user interface. The communication unit 43 transmits the analysis condition with respect to the information analysis device 30, and receives the analysis information from the information analysis device 30. The received analysis information is acquired by the analysis information acquisition unit 412. The analysis information acquisition unit 412 displays the acquired analysis information with respect to the display unit 44. Accordingly, the user of the analysis information reference terminal 40 is capable of referring to various contents such as an image or a diagram corresponding to the analysis information.

<Specific Example of Display Corresponding to Analysis Information>

Next, a specific example of display corresponding to the analysis information will be described with reference to FIGS. 7 to 10. First, a map of the vicinity of a facility that is a current analysis target is displayed on the basis of the map information 321, as a premise. An example of the map is illustrated in FIG. 7.

In this example, in the analysis condition, a “start position on an outbound route” of a “store A, a store B, and a store C” as the facility is designated as the analysis target. In the example of FIG. 7, these three stores, and the identification factors for creating the segment line information 322 described above are illustrated. Specifically, three icons of a store A 51, a store B 52, and a store C 53 indicating the three stores are illustrated. In addition, a oo river 54, a railway 55, and an arterial road 56 are illustrated as the identification factors. Furthermore, facilities other than the three stores, or roads other than the arterial road 56 are not illustrated. In addition, in the drawing described below, the reference numerals of the 00 river 54, the railway 55, and the arterial road 56 are not illustrated in consideration of the ease of illustration.

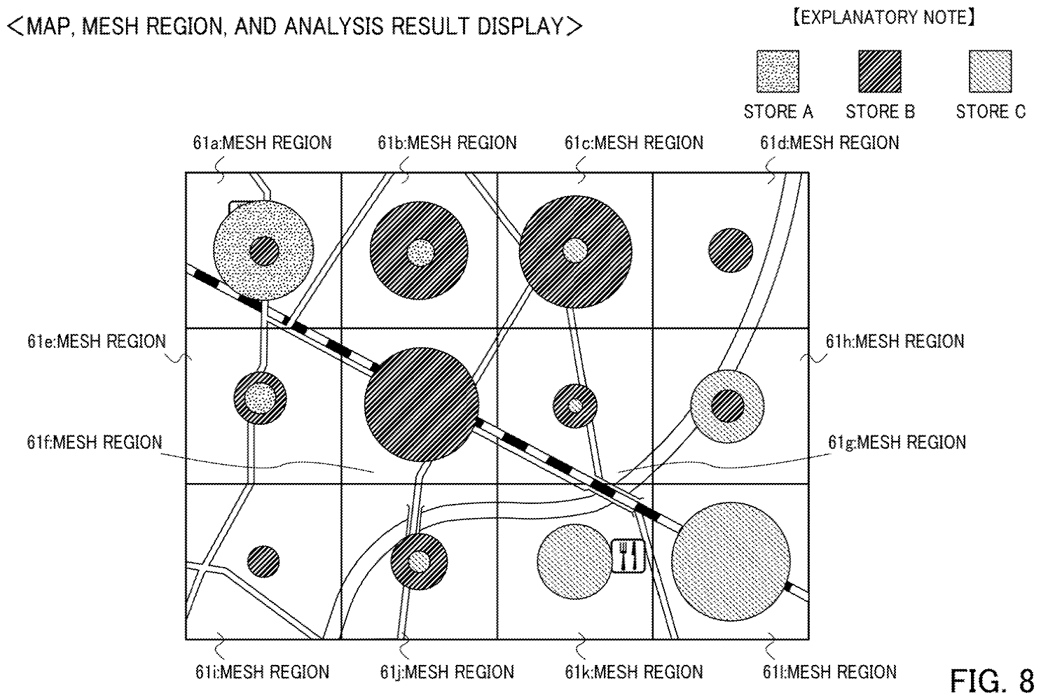

Then, in a case where image data corresponding to the analysis information that is generated on the basis of the analysis condition described above is displayed on the display unit 44, for example, the image data is displayed as illustrated in FIG. 8. FIG. 8 is a diagram illustrating an example in which the corresponding analysis result (that is, the “start position on the outbound route” of the “store A, the store B, and the store C”) is displayed by being overlaid on each rectangular mesh-like mesh region 61 that is obtained by segmenting a map into the shape of a lattice, without using the segment line information 322. In this example, the number of start positions on the outbound route in the mesh-like region is displayed by being overlaid with a corresponding mesh region 61a to a corresponding mesh region 611 in the shape of a circle. The circle becomes larger as the number of start positions on the outbound route increases. In addition, the colors or the patterns of the circles are different in accordance with the stores such that it is possible to determine which position at the time of visiting to which of the store A, the store B, and the store C is the start position on the outbound route. In the drawing, the types of hatching are different from each other, and thus, it is possible to determine which position at the time of visiting to which of the store A, the store B, and the store C is the start position on the outbound route. Furthermore, a correspondence between the type of hatching and each of the stores is as illustrated in [Explanatory Note] on the upper right portion in the drawing.

For example, with reference to the mesh region 61a in the drawing, it is known that there are many vehicles 60 visiting to the store A in the region by setting the mesh region 61a to the start position on the outbound route. On the other hand, it is known that there are a few vehicles 60 visiting to the store B out of the region by setting the mesh region 61a to the start position. The user is capable of carrying out a trading zone analysis or the like with reference to such an image.

Next, the case of using the segment line information 322 will be described with reference to FIGS. 9 and 10. FIG. 9 illustrates an example in which only the map information and the segment line information are displayed in order to describe the segment line information 322. As described above, the segment line information is information that is created on the basis of the identification factors, and segment regions corresponding to the identification factors are generated by the segment line information. For example, the segment is performed as with segment regions 71a to 711 in the drawing.

Next, FIG. 10 illustrates an example in which the corresponding analysis result (that is, the “start position on the outbound route” of the “store A, the store B, and the store C”) is displayed by being overlaid on each segment region 71, in the map information and the segment line information described with reference to FIG. 9. Furthermore, in FIG. 10, displaying the analysis result as a circle, a display method of the circle, or the correspondence between the type of hatching and each of the stores are identical to the contents described with reference to FIG. 8.

For example, in the case of displaying the segment regions 71a and 71b in the drawing, it is known that there are many start positions on the outbound route at the time of visiting to the store A, in such regions. On the other hand, it is known that there are a few start positions on the outbound route at the time of visiting to the store B. This indicates that there are a few vehicles 60 visiting to the store B by setting the segment regions 71a and 71b to the start position. For example, in a case where the segment regions 71a and 71b are a residential district, it is known that there are many customers visiting to the store A from the own home, but there are a few customers visiting to the store B from the own home. That is, a trading zone of the store A can be obviously distinguished from a trading zone of the store B.

On the other hand, with reference to the mesh region 61a in FIG. 8, as described above, there should be many customers visiting to the store B. This is because the customers in the segment region 71c in FIG. 10 are included in the mesh region 61a in FIG. 8. However, it is not possible to grasp that the trading zones are divided on the arterial road, only with reference to the mesh region 61a in FIG. 8.

Similarly, for example, with reference to the mesh region 61a in FIG. 8, it is known that there are both of the customers visiting to the store B and the customers visiting to the store C together, in such a region. On the other hand, with reference to the segment region 71d and the segment region 71e in FIG. 10, it is obviously known that the trading zones are divided on the 00 river 54 (the reference numerals are not illustrated), in the store B and the store C.

As described above, in the case of referring to a rectangular mesh region as with FIG. 8, there is also a case where the trading zones are not capable of being obviously distinguished, but it is known that an effect is obtained in which the segment region 71 is sectioned by the segment line information 322 based on the identification factors, and thus, it is possible to more obviously know the trading zone of each of the stores (that is, the start position of the visiting customer). Furthermore, expression using the circle as described above is merely an example, and in each of the regions, the number of start positions on the outbound route included in the region may be represented by a number, or may be represented by another expression method such as a bar graph.

### Operation of this Embodiment

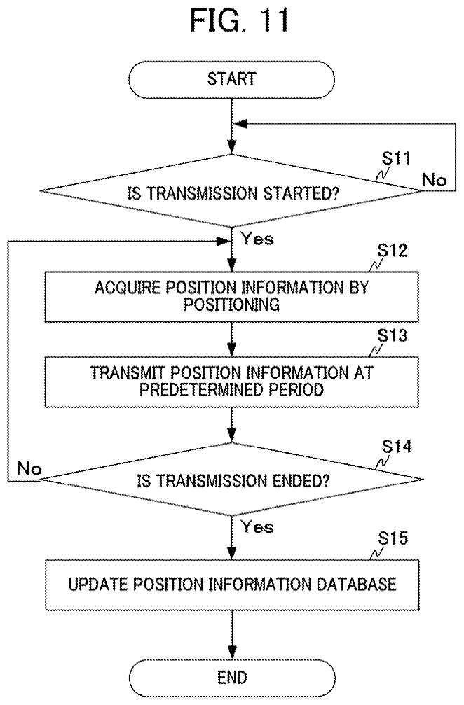

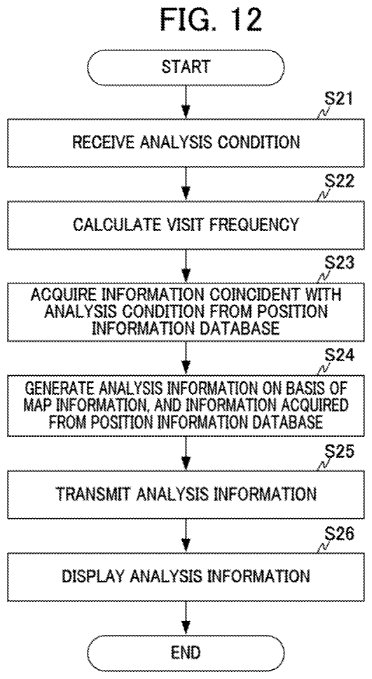

Next, an operation of this embodiment will be described with reference to flowcharts of FIGS. 11 and 12. Here, FIG. 11 is a flowchart illustrating an operation at the time of collecting the position information and of updating the position information database. In addition, FIG. 12 is a flowchart illustrating an operation at the time of information analysis processing.

First, the operation at the time of collecting the position information with respect to the onboard navigation device 10 and of updating the position information database will be described with reference to FIG. 11. The position information transmitting unit 112 determines whether or not to start the transmission of the position information (Step S11). Here, as described above, in a case where the vehicle 60a is in the ignition-switch-on state, the transmission is started. In the case of the ignition-switch-off state (No in Step S11), the transmission of the position information transmitting unit 112 is not started. On the other hand, in the case of the ignition-switch-on state (Yes in Step S11), the process proceeds to Step S12.

In Step S12, the sensor unit 14 acquires the position information by positioning the onboard navigation device 10 (Step S12). The position information transmitting unit 112 acquires the position information from the sensor unit 14, and performs the real-time transmission or the burst transmission of the acquired position information with respect to the information analysis device 30 at a predetermined period (Step S13).

Next, the position information transmitting unit 112 determines whether or not to end the transmission of the position information (Step S14). As described above, in a case where the vehicle 60a is in the ignition-switch-off state, the transmission is ended. In a case where the vehicle 60a is in the ignition-switch-on state (No in Step S14), the positioning in Step S12 and the transmission in Step S13 are repeated.

On the other hand, in a case where the vehicle 60a is in the ignition-switch-off state (Yes in Step S14), the process proceeds to Step S15.

In Step S15, the position information database updating unit 311 of the information analysis device 30 updates the position information database 323 on the basis of the position information that is transmitted by repeating Step S12 and Step S13 (Step S15). According to the operation described above, the collection of the position information and the update of the position information database are realized.

Next, the operation at the time of collecting the position information with respect to the portable terminal 20 and of updating the position information database will be described. In the portable terminal 20, as described above, the position information transmitting unit 112 may be replaced with the position information transmitting unit 211, the sensor unit 14 may be replaced with the sensor unit 24, the standard to be Yes in Step S11 may be replaced with a “case where the activation switch of the vehicle 60b, such as the ignition switch, is set to On, and the vehicle 60b and the portable terminal 20 are paired with each other”, and the standard to be Yes in Step S14 may be replaced with a “case where the activation switch of the vehicle 60b, such as the ignition switch, is set to Off, and the pairing between the vehicle 60b and the portable terminal 20 is released”. Accordingly, the overlapped description will be omitted.

Next, the operation at the time of generating the analysis information will be described with reference to the flowchart of FIG. 12. First, the analysis condition receiving unit 411 of the analysis information reference terminal 40 receives the analysis condition from the user through the input unit 45 (Step S21).

Then, the analysis condition receiving unit 411 transmits the received analysis condition with respect to the information analysis device 30 (Step S22).

The analysis information generation unit 312 of the information analysis device 30 that receives the analysis condition acquires the information based on the analysis condition from the position information database 323 (Step S23). For example, a departure position on the outbound route or the parking position on the return route with respect to the facility that is designated by the analysis condition is acquired. In a case where the time zone or the like is designated, only the information according to the designation is further acquired.

Next, the analysis information generation unit 312 generates analysis information on the basis of the map information 321, the segment line information 322, and the information that is acquired from the position information database 323 in Step S23 (Step S24).

Further, the analysis information generation unit 312 transmits the generated analysis information with respect to the information analysis device 30 (Step S25).

The analysis information acquisition unit 412 of the analysis information reference terminal 40 that receives the analysis information displays the acquired analysis information with respect to the display unit 44 (Step S26). Accordingly, for example, the display is performed as described with reference to FIG. 10.

According to this embodiment described above, an effect is obtained in which it is possible to set a more suitable region to carry out an analysis, and then, it is possible to carry out the analysis.

<Advantages of Analysis Information>

Then, an effect is also obtained in which it is possible to use the analysis information that is obtained as described above as information advantageous for the user. The effects will be described in detail. For example, in this embodiment, the position information is analyzed, and thus, it is possible to generate the analysis information for carrying out the display as illustrated in the example of FIGS. 7 to 10. Then, as described above with reference to FIGS. 7 to 10, the analysis information is displayed, and thus, it is possible to visualize where the vehicle 60 visiting to the facility comes from or where the vehicle 60 visiting to the facility goes to. For this reason, the user referring to the analysis information is capable of knowing the range of the trading zone of each of the facilities, the number of customers included in the trading zone (the scale of the trading zone), and the like. For example, it is known that regions that are separated by a river are not the trading zone even through a distance between the regions is close.

For this reason, for example, it is possible to use the analysis information for determining which area is effective for distributing a flyer, a coupon, or the like. For example, in the case of moving to a region where there is a complex housing after visiting to the facility, it is known that it is effective to distribute the flyer, the coupon, or the like to the complex housing. In addition, for example, in a case where there are many vehicles 60 visiting to the facility by setting a neighborhood shopping center to the start position, it is known that it is effective to place the flyer, the coupon, or the like in the shopping center.

In addition, for example, in the case of a user having a plurality of stores as the facility, it is known that the trading zone of which store is wide, the trading zones of a certain store and the other store overlap with each other, and there is a region that is not included in any trading zone of the stores. For this reason, for example, it is possible to use the analysis information in this embodiment in a store opening plan of a new store, or on the contrary, a store closing plan, a plan to support the store, and the like.

Further, various analysis information items are acquired in accordance with various analysis conditions, and thus, it is possible to perform verification by comparing various analysis information items. For example, the analysis information is acquired with respect to each of the vehicle 60 visiting to the facility at a certain time zone or the like, and the vehicle 60 visiting to the facility at the other time zone, and thus, it is possible to perform verification by comparing different tendencies.

As described above, according to this embodiment, it is possible to provide information advantageous for the user. Furthermore, the analysis information, for example, is advantageous even in the case of being used by an organizer of the facility, or is advantageous in the case of being used by a consultant of the facility. For example, in addition to the consultant with respect to the same brand, it is possible for a content provider to perform consultancy by comparing trading zones of stores of a plurality of brands through the content provider.

<Hardware and Software>

Furthermore, each device included in the navigation system described above can be realized by hardware, software, or a combination thereof. In addition, a navigation method performed by a cooperation between the devices included in the navigation system described above can be realized by hardware, software, or a combination thereof. Here, the navigation method being realized by software indicates that a computer reads and executes a program, and thus, the navigation method is realized.

The program can be stored by using various types of non-transitory computer readable media, and can be supplied to the computer. The non-transitory computer readable medium includes various types of tangible storage media. Examples of the non-transitory computer readable medium include a magnetic storage medium (for example, a flexible disk, a magnetic tape, and a hard disk drive), a magnetooptical storage medium (for example, a magnetooptical disk), a CD-read only memory (ROM), a CD-R, a CD-R/W, and a semiconductor memory (for example, a mask ROM, a programmable ROM (PROM), an erasable PROM (EPROM), a flash ROM, and a random access memory (RAM)). In addition, the program may be supplied to the computer by various types of transitory computer readable media. Examples of the transitory computer readable medium include an electric signal, an optical signal, and an electromagnetic wave. The transitory computer readable medium is capable of supplying the program to the computer through wired communication path such as an electric wire and an optical fiber, or a wireless communication path.

### Modification Example

The embodiment described above is a preferred embodiment of the present invention, but the scope of the present invention is not limited only to the embodiment described above, and is capable of including embodiments in which various changes are carried out within a range not departing from the gist of the present invention.

For example, the functional configurations of FIGS. 2, 3, 4, and 6 are merely an example, and are not limited to the functional configurations of this embodiment. That is, it is sufficient that each device has a function capable of executing a set of processing relevant to an information analysis function of the present invention as a whole, and using which functional block to realize the function is not particularly limited to the examples of FIGS. 2, 3, 4, and 6.

In addition, as another modification example, the onboard navigation device 10 or the portable terminal 20 may be realized by other devices not having a route guidance function. That is, the route guidance function of the onboard navigation device 10 or the portable terminal 20 is not a required component. In this case, the information analysis device 30 may further have the route guidance function, and the information analysis device 30 may communicate with the onboard navigation device 10 or the portable terminal 20, and thus, may perform the route guidance.

Further, as another modification example, in the embodiment described above, it has been described that the information analysis device 30 is realized by one server device or the like, but a dispersion processing system may be used in which the functions of the information analysis device 30 are suitably dispersed to a plurality of server devices, respectively. In addition, a virtual server function or the like is used on a cloud, and thus, each of the functions of the information analysis device 30 may be realized.

Further, as another modification example, the information analysis device 30 may have a function as the analysis information reference terminal 40. That is, an input unit and a display unit may be provided in the information analysis device 30, the analysis condition may be received from the user by the input unit of the information analysis device 30, and the analysis information may be displayed on the display unit of the information analysis device 30. In addition, the functions of the analysis information reference terminal 40 can be segmented and divided into an analysis condition input device and an analysis condition reference device. The information analysis device 30 is also capable of having one of the divided functions.

### EXPLANATION OF REFERENCE NUMERALS

1 INFORMATION ANALYSIS SYSTEM
10 ONBOARD NAVIGATION DEVICE
11, 21, 31, 41 CONTROL UNIT
111, 211 ROUTE GUIDING UNIT
112, 212 POSITION INFORMATION TRANSMITTING UNIT
12, 22, 32, 42 STORAGE UNIT
121, 221 POSITION INFORMATION
122, 222 DISCRIMINATION INFORMATION
13, 23, 33, 43 COMMUNICATION UNIT
14, 24 SENSOR UNIT
15, 25, 44 DISPLAY UNIT
16, 26, 45 INPUT UNIT
20 PORTABLE TERMINAL
27 NEAR FIELD COMMUNICATION UNIT
30 INFORMATION ANALYSIS DEVICE
311 POSITION INFORMATION DATABASE UPDATING UNIT
312 ANALYSIS INFORMATION GENERATION UNIT
321 MAP INFORMATION
322 SEGMENT LINE INFORMATION
323 POSITION INFORMATION DATABASE
40 ANALYSIS INFORMATION REFERENCE TERMINAL
411 ANALYSIS CONDITION RECEIVING UNIT
412 ANALYSIS INFORMATION ACQUISITION UNIT
50 COMMUNICATION NETWORK
60a, 60b VEHICLE

1. An information analysis device, comprising:
a receiving unit that receives position information of a plurality of movable bodies;
a storage unit that stores map information including a facility position relevant to a plurality of facilities, and identification factors, and segment line information created by using the identification factors included in the map information; and
an analysis information generation unit that identifies any one or both of a start position on an outbound route and a parking position on a return route when the movable body visits to any one facility of the plurality of facilities, on the basis of the received position information, and generates analysis information for displaying the identified position overlaid with the map information for each region that is segmented by the segment line information.

2. The information analysis device according to claim 1, wherein the analysis information generation unit further receives designation of at least one facility from the plurality of facilities, identifies any one or both of the start position on the outbound route and the parking position on the return route when the movable body visits to any one of the plurality of designated facilities, on the basis of the received position information, and generates the analysis information for displaying the identified position overlaid with the map information and the segment line information.

3. The information analysis device according to claim 1 or 2, wherein time information indicating a positioning time of the position information is incidental to the position information of the movable body that is received by the receiving unit, and
the analysis information generation unit further receives designation of a time zone, identifies any one or both of the start position on the outbound route and the parking position on the return route when the movable body visits to any one facility of the plurality of facilities at the designated time zone, on the basis of the received position information, and generates the analysis information for displaying the identified position overlaid with the map information and the segment line information.

4. The information analysis device according to any one of claims 1 to 3,
wherein the identification factors of the map information includes at least any one of a river, a railroad, and an arterial road.

5. The information analysis device according to any one of claims 1 to 4,
wherein the analysis information generation unit further generates the analysis information for displaying the identified start position or the identified parking position such that it is possible to determine which position when the movable body visits to which facility is the start position or the parking position.

6. An information analysis device according to any one of claims 1 to 5,
wherein the receiving unit further receives activation information and suspension information of the plurality of movable bodies, and
the analysis information generation unit further identifies a position in which the movable body is activated on the outbound route, as the start position on the outbound route on the basis of the position information and the activation information, and identifies a position in which the movable body is suspended on the return route, as the parking position on the outbound route on the basis of the position information and the suspension information.

7. An information analysis method performed by a computer, the method comprising:
a receiving step of receiving position information of a plurality of movable bodies;
a storing step of storing map information including a facility position relevant to a plurality of facilities, and identification factors, and segment line information created by using the identification factors included in the map information; and
an analysis information generating step of identifying any one or both of a start position on an outbound route and a parking position on a return route when the movable body visits to any one facility of the plurality of facilities, on the basis of the received position information, and of generating analysis information for displaying the identified position overlaid with the map information for each region that is segmented by the segment line information.
